(19) United States
(12) Patent Application Publication
(10) Pub. No.: US 2008/0143139 A1
(43) Pub. Date: Jun. 19, 2008

(54) Vehicle Door Provided with a Get-Out Assisting Device

(75) Inventors: Wolf-Dietrich Bauer, Leinfelden-Echterdingen (NL); Simon Kern, Darmstadt (DE); Juergen Maas, Kelkheim (DE); Bernd Seiler, Stuttgart (DE)

Correspondence Address: CROWELL & MORING LLP;INTELLECTUAL PROPERTY GROUP, P.O. BOX 14300, WASHINGTON, DC, 20044-4300, US

(73) Assignee: Daimlerchrysler AG, Stuttgart (DE)

(21) Appl. No.: 11/793,456

(22) PCT Filed: Dec. 7, 2005
(86) PCT No.: PCT/EP05/13095

§ 371 Date: Jun. 20, 2007

(30) Foreign Application Priority Data
Dec. 22, 2004 (DE) 10 2004 061 689.2

(51) Int. Cl. B60J 1/14; E05C 3/16; G06F 17/00

(52) U.S. Cl. 296/146.1; 292/216; 701/49

(57) ABSTRACT

A vehicle door has an easy exit feature that holds the vehicle door in a desired latched position by applying a latching torque with a controllable damper. An evaluation and control unit detects the desired latched positions by evaluating an instantaneous door movement sensed by a sensor system, and accordingly actuates the damper. The evaluation and control unit releases the latched position after a corresponding activation has been detected. The easy exit feature is embodied as a variable latching function, and applies a maximum holding force to the vehicle door by way of the damper and locks the vehicle door in the desired latched position.

### BACKGROUND AND SUMMARY OF THE INVENTION

This invention relates to a vehicle door with an easy exit feature.

If vehicle doors are opened carelessly, it is easy for collisions with obstacles to occur, resulting in damage to the door or to the obstacle. The frequently occurring scenario is people getting out of the vehicle in tight parking spaces or garages. In this context, it is often necessary to open the door as far as possible against the neighboring vehicle or the wall for it to be possible at all to get out of the vehicle. This requires a latching mechanism with variable latching which allows the door to be positioned precisely. With current latching mechanisms, which generally have only one or two permanently predefined latching positions for the door, this is not possible. The door often opens too wide or does not remain opened.

German document DE 42 24 132 A1 describes a door securing system, in particular for a motor vehicle door or a flap, in which the door is held in any desired intermediate position within the opening area. The door securing system comprises a piston cylinder unit which, by means of connecting elements, is connected on one side to the element to be moved and on the other side to the base element. The piston cylinder unit has a pressure pipe in which a working space filled with a damping medium is divided in two by a piston on a piston rod, wherein the piston rod is guided radially by a piston rod guide. A valve which is arranged inside a flow connection and locks the volume region between the working spaces is actuated in such a way that when a door movement impulse is applied at any desired point on the door, the locking valve opens and remains opened irrespective of the pressure within the door securing system until the locking valve is closed again when a braking impulse is applied to the door.

German document DE 197 54 167 A1 discloses a device for infinitely variable locking of a component which can pivot about an axis, in particular doors and flaps. The described device comprises at least one cylinder and a piston with an electrorheological or magnetorheological liquid, an electronic control system by means of which the electrical or magnetic field strength in the rheological liquid can be adjusted, and a device for sensing or inputting of a desired locking position. The electronic control system can be actuated as a function of the sensed or input locking position. If an obstacle is detected in the planned pivoting region by a camera during the opening process, an electronic evaluation system activates the electronic control system in such a way that the door is locked before the obstacle is reached.

The object of the invention is to provide a vehicle door with an easy exit feature which makes it easier for users of the vehicle to get in and out.

This invention achieves this object by making available a vehicle door with an easy exit feature as claimed.

Advantageous embodiments and developments of the invention are also claimed.

According to the invention, an easy exit feature is embodied as a variable latching function, applies a maximum holding force to a vehicle door by means of a damper, and locks the vehicle door in a desired latched position, which is detected by an evaluation and control unit, by evaluating an instantaneous door movement which is sensed by a sensor system. The easy exit feature according to the invention can advantageously make it significantly easier for the users of the vehicle to get in and out since, in addition to the steering wheel, the seat, the handles in the vehicle, and the A and B pillars, a further holding or supporting facility is provided by means of the lockable vehicle door.

The easy exit feature is, for example, activated or deactivated by means of at least one activation means.

In an embodiment of the vehicle door according to the invention, the easy exit feature acts on the vehicle door within a functional region which extends over a predefined opening region between a first opening angle and a maximum opening angle if the vehicle door drops below a predefined speed or comes to a standstill within the functional region.

Since it is not possible to get in or out of the vehicle when a vehicle door is only slightly opened, the functional region of the variable latching function does not extend over the entire opening region of the vehicle door, i.e. in a first segment of the opening region of the vehicle door, for example to an opening angle of 15°, the vehicle door is not locked when a stationary state is detected.

The functional region can be restricted, for example, by a detected obstacle to an opening region which extends between the first opening angle and an opening angle which is predefined by the detected obstacle.

In a further refinement of the vehicle door, the maximum holding torque for locking the vehicle door in the desired latched position can be applied or released in a timed fashion. This advantageously prevents jolting, and the locking process is configured in a haptically pleasant way for a user.

The maximum holding torque can be applied, for example, by means of a first PT₂ element with a first time constant, or can be released by means of a second PT₂ element with a second time constant.

The evaluation and control unit detects the activation for releasing the latched position if, for example, the user grasps the internal or external door handle.

In a further refinement of the vehicle door according to the invention, a corresponding sensor system monitors the internal or external door handle for activation by the user.

Various appropriate embodiments which are obtained from any desired combination of the subject matters of the subclaims are not explicitly specified. However, they are all to be considered as belonging to the invention.

One advantageous embodiment of the invention is illustrated in the drawings and will be described below.

### BRIEF DESCRIPTION OF THE DRAWINGS

FIG. 1 is a schematic block diagram of the components of a vehicle door which are significant for the invention,

FIG. 2 is a more detailed block diagram of the vehicle door from FIG. 1,

FIG. 3 is a schematic illustration of a movement region of the vehicle door from FIG. 1, and

FIG. 4 is a schematic state diagram of the vehicle door from FIG. 1.

### DETAILED DESCRIPTION OF THE INVENTION

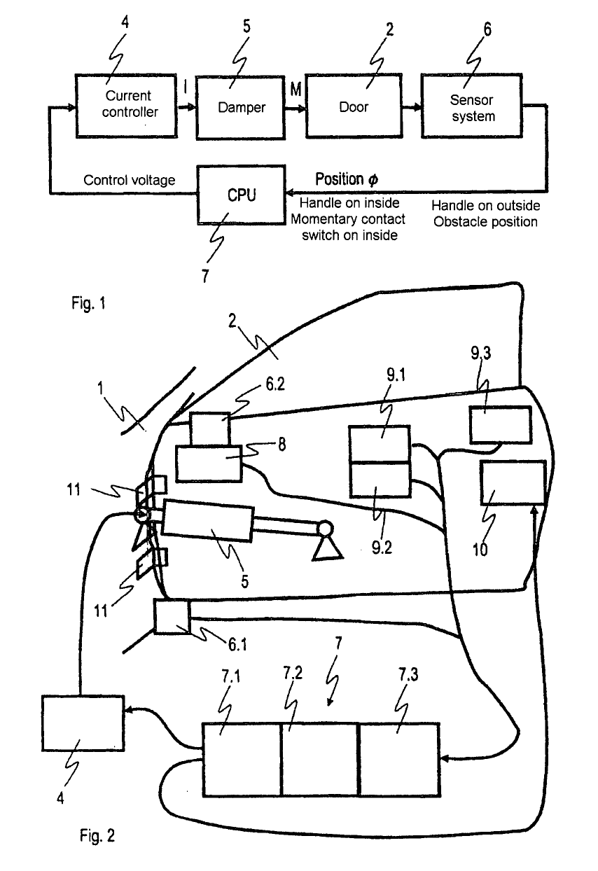

As is apparent from FIG. 1, a vehicle door 2 according to the invention comprises a sensor system 6 for sensing the door movement, an evaluation and control unit 7 for evaluating the sensed door movement and for actuating a damper 5 by means of an actuator element 4, in which the damper influences the movement of the vehicle door 2 by means of a set torque M. The evaluation and control unit 7 outputs, for example, a control voltage U which is converted by the actuator element 4 into a current I. In addition to the sensing of the door movement, the sensor system 6 can also comprise sensors for monitoring an internal or external door handle or for detecting obstacles in the opening region of the vehicle door 2.

FIG. 2 shows a more detailed block diagram of the vehicle door 2. As is apparent from FIG. 2, the vehicle door 2 comprises hinges 11, the damper 5, with the actuator element 4 which is embodied as a current controller and which is actuated by the evaluation and control unit 7, an internal handle 9.1, an external handle 9.3, a momentary contact switch 9.2 which is arranged in the surroundings of the internal handle 9.1, and a unit 10 for releasing the door lock, which unit 10 is activated by means of the evaluation and control unit 7. In order to evaluate the sensor signals and to output control signals, the evaluation and control unit 7 comprises a CPU 7.2 and an analog/digital converter 7.3 which prepares the received sensor signals for processing in the CPU 7.2, and a digital/analog converter 7.1 which correspondingly prepares the control signals from the CPU for outputting. For the purpose of receiving and for outputting, the evaluation and control unit additionally has digital inputs and outputs.

As is also apparent from FIG. 2, the sensor system 6 comprises a position sensor 6.1, which detects the opening angle Ø of the vehicle door and transmits a corresponding signal to the evaluation and control unit 7, and a digital laser scanner 6.2 with associated control unit 8 for detecting obstacles. Optionally, further sensors can be arranged on the internal or external handle 9.1, 9.3 of the vehicle door 2 and connected to the evaluation and control unit 7. These sensors detect activation of the associated handle 9.1, 9.3 and communicate it to the evaluation and control unit 7.

The illustrated hinges 11 of the vehicle door 2 do not have any fixed latching means but rather permit low-force activation of the vehicle door independently of position. The hinges 11 are embodied in such a way that in a first segment 400 of the opening region of the vehicle door 2 from a minimum opening angle Ø₀ up to a first opening angle Øₘᵢₙ, which is, for example, approximately 15°, the associated vehicle door 2 engages in the lock, that is to say is accelerated to relatively small positions in the direction of the minimum opening angle Ø₀, without the effect of external forces.

In the enabled state, the damper 5 used has low friction, and its holding force corresponds to a holding/braking torque of approximately 100 Nm. The damper 5 is embodied in such a way that it can be satisfactorily applied and responds quickly to the control signals.

In order to implement the variable latching function and the easy exit feature, various designs and principles of action can be selected for the damper 5. In principle, the damper 5 can be divided into rotary action and translatory action dampers. The possible actuators 4 for actuating the dampers 5 can be classified as electrohydraulic, electromechanical, magnetorheological and electrorheological principles of action. It is also possible to use active actuating units such as electromotors, which have a rotary or linear action, and hydraulic drives.

For the easy exit feature, the position of the vehicle door 2, which is sensed, for example, as an opening angle Ø by the position sensor 6.1, is evaluated. The angular speed can be estimated by suitable filtering and differentiation of the signal of the position sensor 6.1. The low pass filtering which is used constitutes here a compromise between a signal which is as “smooth” as possible and which has minimum noise and a sufficiently unfalsified system movement with short delays. Angle sensors which operate according to the Hall principle or are embodied as rotary potentiometers can be used as position sensors 6.1. Furthermore, linear-action length measuring systems with which the position of the vehicle door 2 can be determined can also be used. In one particularly advantageous embodiment of the vehicle door 2, the displacement of the damper 5 is not sensed; rather, the position of the vehicle door 2 itself, including the movements which occur owing to the elasticities in the mechanism of the vehicle door 2 and of the damper 5, is sensed. If the position sensor 6.1 is integrated into the damper 5, elastic resilience is explicitly provided in the structure of the damper 5 and permits the sensor 6.1 to be able to sense a movement of the vehicle door 2 within the scope of its resilience even when the damper 5 is locked.

The sensor 6.2 for detecting obstacles detects the position of objects in the opening region of the vehicle door 2, either in relation to the vehicle 1 or in relation to the current position of the vehicle door 2. In the illustrated exemplary embodiment, the obstacle sensor 6.2 is embodied as a laser scanner with an oscillating deflecting mirror. The laser scanner 6.2 is arranged on the vehicle door 2 in such a way that a plane which passes through the hinge axis but which is at a corresponding angle to the surface of the vehicle door 2 is scanned. As a result, obstacles which are approaching the vehicle door 2 can be detected in good time. In such an arrangement of the obstacle sensor 6.2, no information is required about the precise position of the obstacle in space since the distance from the vehicle door 2 can be determined in a uniquely defined way in the relevant angle coordinates.

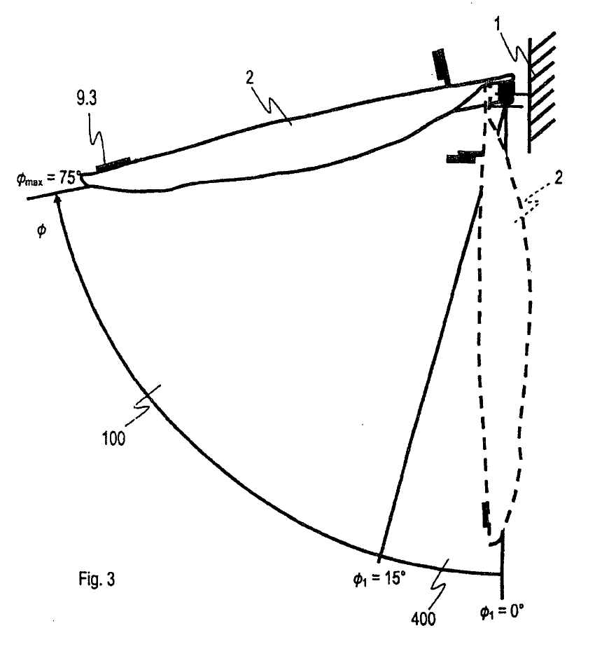

FIG. 3 shows the functional region 100 of the variable latching function which act as an easy exit feature. As is apparent from FIG. 3, in the illustrated exemplary embodiment, the functional region 100 of the easy exit feature extends from the first opening angle Øₘᵢₙ=15° up to the maximum opening angle Øₘₐₓ=75°. If the vehicle door 2 is brought to a standstill at any desired position within the functional region 100 of the easy exit feature or if the speed of the vehicle door 2 drops below a threshold value, the vehicle door 2 is locked at precisely this position by the maximum holding torque of the damper 5. If the obstacle sensor 6.2 detects an obstacle within the opening region, the possible opening angle is limited in such a way that damage to the vehicle door 2 during the opening process is prevented. As a result, the functional region of the easy exit feature is also reduced to the region which is less than the opening angle and which is predefined by the detected obstacle.

As is also apparent from FIG. 3, the functional region 100 of the easy exit feature does not extend over the entire opening region of the vehicle door 2. In the first segment 400 of the opening region of the vehicle door 2 up to the first opening angle Øₘᵢₙ=15°, the vehicle door 2 is not locked. Since it is not possible to get in or out of the vehicle with such a small opening angle, this has an adverse effect on comfort. As a result of the embodiment of the hinges 11 which is described above, the vehicle door 2 engages in the lock when it is positioned within the first segment 400 of the opening region. This functionality is further ensured by the limiting of the functional region 100 of the easy exit feature. The vehicle door 2 is illustrated with the maximum possible opening angle Øₘₐₓ=75°. A vehicle door 2 which is illustrated by dashed lines shows the initial position of the vehicle door 2 with the minimum opening angle Ø₀=0°, i.e. the closed vehicle door 2.

The maximum holding torque is applied in a timed fashion, for example in accordance with a jump response of a PT₂ element in order to prevent jolting and thus make the locking of the vehicle door 2 haptically pleasant for the user. The vehicle door 2 is locked in its latched position by the maximum holding torque.

The easy exit feature can, for example, be switched off if an activation request is sensed by means of a mechanical momentary contact switch which is let into the external handle 9.3 of the vehicle door 2 and with which it is detected whether the operator is gripping the handle 9.3, or by means of a capacitive sensor on the internal handle 9.1 of the vehicle door 2. In addition to these sensors, which detect the driver's hand on the handle 9.1, 9.3, a further momentary contact switch can be arranged at the upper end of the internal handle. Other sensors can also be used to sense the activation request. By means of the sensors it is detected whether the driver grasps the internal or external door handle 9.1, 9.3. If this is the case, the maximum holding force is switched off so that the driver can move the vehicle door 2 out of its latched position without applying force. The maximum holding torque is eliminated in a timed fashion, for example in accordance with a jump response of a PT₂ element, in order to prevent jolting and thus make the release of the locking of the vehicle door 2 haptically pleasant for the user.

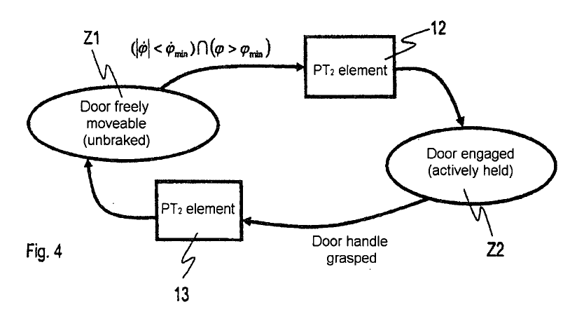

FIG. 4 shows a schematic state diagram of the vehicle door 2 according to the invention with an easy exit feature. As is apparent from FIG. 4, the vehicle door 2 is freely moveable in a first state Z1 and, if the current opening angle lies within the functional region 100 and the speed drops below a threshold value, the maximum holding torque is applied to said vehicle door 2 by means of a PT₂ element 12 with a first time constant and by means of the damper 5. In a second state Z2, the vehicle door 2 is actively locked by means of the maximum holding torque until the evaluation and control unit 7 detects, by means of a corresponding sensor system, that the user grasps the internal or external door handle 9.1, 9.3. The maximum holding torque is released by means of a second PT₂ element 13 with a second time constant, and the vehicle door 2 returns to the first freely moveable state Z1. The PT₂ filters 12, 13 ensure jolt free application and elimination of the maximum holding torque and can have various time constants, as a result of which the overall comfort of the system is perceptibly increased. As a result of the high holding forces, the users of the vehicle are provided with additional holding and supporting possibilities when they get in and out of the vehicle by virtue of the locked vehicle door.

Getting in and out of a vehicle can be made significantly easier for the user of the vehicle if he has the possibility of supporting himself not only on the steering wheel, the seat, the handles in the vehicle and the A and B pillars but also on the door. The easy exit feature locks the door in any desired position and can serve as a handrail or support for the user of the vehicle.

The door can be opened and positioned from the closed position without the application of force. If the door comes to a standstill, i.e. the speed of the door drops below a threshold value, the door is held with a maximum holding force. The door is released again by gripping the internal or external door handle.

1-8. (canceled)

9. A vehicle door with an easy exit feature, comprising:
a controllable damper adapted to hold the vehicle door in a desired latched position by applying a latching torque,
a sensor system that senses an instantaneous door movement,
an evaluation and control unit that detects the desired latched position by evaluating the instantaneous door movement sensed by the sensor system and accordingly actuates the damper,
wherein the evaluation and control unit releases the latched position after a corresponding activation has been detected, and
wherein a variable latching function provides the easy exit feature and applies a maximum holding force to the vehicle door by way of the damper and locks it in the desired latched position.

10. The vehicle door as claimed in claim 9, wherein the easy exit feature can be activated and deactivated by at least one manual activator.

11. The vehicle door as claimed in claim 9, wherein the easy exit feature acts on the vehicle door within a functional region that extends over a predefined opening region between a first opening angle and a maximum opening angle when the vehicle door drops below a predefined speed or comes to a standstill within the functional region.

12. The vehicle door as claimed in claim 11, wherein the functional region is restricted by a detected obstacle to an opening region extending between the first opening angle and an opening angle predefined by the detected obstacle.

13. The vehicle door as claimed in claim 9, wherein the maximum holding torque for holding the desired latched position can be applied or released in a timed fashion.

14. The vehicle door as claimed in claim 13, wherein the maximum holding torque can be applied or released by means of a PT₂ element.

15. The vehicle door as claimed in claim 9, wherein the evaluation and control unit detects activation for releasing the latched position when a user grasps an internal or an external door handle.

16. The vehicle door as claimed in claim 15, further comprising a corresponding sensor system that monitors the internal or the external door handle for activation by the user.

17. The vehicle door as claimed in claim 10, wherein the easy exit feature acts on the vehicle door within a functional region that extends over a predefined opening region between a first opening angle and a maximum opening angle when the vehicle door drops below a predefined speed or comes to a standstill within the functional region.

18. The vehicle door as claimed in claim 17, wherein the functional region is restricted by a detected obstacle to an opening region extending between the first opening angle and an opening angle predefined by the detected obstacle.

19. The vehicle door as claimed in claim 10, wherein the maximum holding torque for holding the desired latched position can be applied or released in a timed fashion.

20. The vehicle door as claimed in claim 11, wherein the maximum holding torque for holding the desired latched position can be applied or released in a timed fashion.

21. The vehicle door as claimed in claim 12, wherein the maximum holding torque for holding the desired latched position can be applied or released in a timed fashion.

22. The vehicle door as claimed in claim 10, wherein the evaluation and control unit detects activation for releasing the latched position when a user grasps an internal or an external door handle.

23. The vehicle door as claimed in claim 11, wherein the evaluation and control unit detects activation for releasing the latched position when a user grasps an internal or an external door handle.

24. The vehicle door as claimed in claim 12, wherein the evaluation and control unit detects activation for releasing the latched position when a user grasps an internal or an external door handle.

25. The vehicle door as claimed in claim 13, wherein the evaluation and control unit detects activation for releasing the latched position when a user grasps an internal or an external door handle.

26. The vehicle door as claimed in claim 14, wherein the evaluation and control unit detects activation for releasing the latched position when a user grasps an internal or an external door handle.

27. The vehicle door as claimed in claim 19, wherein the maximum holding torque can be applied or released by means of a PT₂ element.

28. The vehicle door as claimed in claim 22, further comprising a corresponding sensor system that monitors the internal or the external door handle for activation by the user.
